(19) United States
(12) Patent Application Publication
(10) Pub. No.: US 2019/0295079 A1
(43) Pub. Date: Sep. 26, 2019

(54) CONTROL SYSTEM AND METHOD FOR CONTROLLING PRIVATE BLOCKCHAIN SYSTEM

(71) Applicant: Graph Blockchain Limited, Toronto (CA)

(72) Inventor: Suk Min Bae, Seoul (KR)

(73) Assignee: Graph Blockchain Limited, Toronto (CA)

(21) Appl. No.: 16/359,309

(22) Filed: Mar. 20, 2019

Related U.S. Application Data
(60) Provisional application No. 62/647,070, filed on Mar. 23, 2018.

(30) Foreign Application Priority Data
Mar. 26, 2018 (KR) 10-2018-0034218

(51) Int. Cl. G06Q 20/40; G06F 16/182; G06F 16/901; G06Q 20/38; H04L 9/06

(52) U.S. Cl. CPC G06Q 20/401; G06F 16/1824; G06F 16/1834; H04L 2209/38; G06Q 20/382; H04L 9/0643; G06F 16/9024

(57) ABSTRACT

A control system and method for controlling a private blockchain system are provided. The method includes: a process of acquiring input data of the private blockchain system based on a permissioned distributive ledger technology; a process of classifying the input data into a plurality of nodes, edges among the nodes, and property information dependently added to each of individual nodes and individual edges, and loading them in a graph database generated on a basis of a directional graph theory; a process of analyzing graph data loaded in the graph database; and a process of visualizing the graph data to a graph and displaying the graph on a screen. Herein, the graph data is a data model represented by points denoting the nodes having the property information, and lines denoting the edges having the property information and connecting the points to each other.

### CROSS-REFERENCE TO RELATED APPLICATIONS

This application claims the benefit of provisional application No. 62/647,070 filed Mar. 23, 2018 and KR application No. 10-2018-0034218 filed Mar. 26, 2018, the contents of which are incorporated by reference herein in their entirety.

### BACKGROUND OF THE INVENTION

### Field of the Invention

The present invention relates to a control system and a method for controlling a private blockchain system.

### Description of the Related Art

After Bitcoin based on blockchain was disclosed in 2009, the blockchain has been applied to various fields such as a platform providing service for smart contracts, cloud storage services, and blockchain computing services, as well as a cryptocurrency system such as Bitcoin.

The blockchain is a technology which maintains security and integrity in a decentralized network environment without a centralized server or organization, and is a linked list, with each subsequent block having a hash value for a previous block, starting from the first block (genesis block) by link.

The blockchain is identically copied, distributed, and stored over many peers, commonly known as nodes, in which a block includes information about a transaction ‘who transmitted what and when and to whom’ or a transaction history. Accordingly, the blockchain, which is an aggregate of blocks, may be called a massive distributed-type ledger or book including information about all transaction histories.

All the peers participating in a blockchain network individually store and manage the same transaction ledger, and individually verify validity or authenticity in respect of a transaction newly generated, on the basis of the corresponding transaction ledger. Transactions under predetermined conditions agreed to be verified among peers in accordance with the verification result are bundled into one block and are stored, and the corresponding block propagates to all the peers and is linked in the form of being added to the back of the previous block, and the process is repeated, thereby updating the blockchain stored in all the peers.

In the blockchain, not only are successive blocks (the front and rear blocks) linked by a hash value, but also only the transaction agreed among peers is stored in a block. Accordingly, it is technically impossible to forge the information stored in the block, or to manipulate a transaction for malicious purposes.

In addition, the blockchain is classified into a public blockchain which is a permissionless distributive ledger technology and a private blockchain which is a permissioned distributive ledger technology.

In the case of the public blockchain, anyone can anonymously browse the transaction histories and can perform work such as transaction participation, verification, storage, and consensus, etc. However, in the case of the private blockchain, only permissioned organizations and institutions can perform such work.

Meanwhile, the blockchain is a distributed-type database, and utilizes a P2P (peer to peer) network in which a computer of each user plays a role of a server and a client. The distributed-type database means a technology of physically distributing data and making a plurality of users share large databases, and has characteristics of low costs and high reliability and availability.

However, even though the blockchain is a distributed-type database, the blockchain itself does not provide a query or a client tool for data access and search, and it is difficult to utilize the blockchain in of itself as a general database.

Specifically, in order to have utilization as a database, a user should be able to freely perform at least one action such as querying, creating, deleting, and updating of the data within the database. However, the block of the blockchain cannot be, at a basic level, updated and deleted, and the block can only be created by a peer in the P2P network.

Accordingly, in order to efficiently utilize the blockchain like a general database, it is necessary to study technology that is capable of querying an overall state or transaction flow of a system based on the blockchain (particularly, private blockchain) and visualizing and tracking the internal data stored in the blockchain.

In addition, the internal data of the blockchain is stored in a key-value format. The internal data of the key-value format must be normalized or migrated before storing in the existing relational database (for example, Oracle, MySQL, MS-SQL, PostgreSQL, etc.). The extra calculation (for example, ‘join’ calculation) is necessary to process the internal data, and it is not suitable for storing the internal data in the existing relational database because of the increase of the extra calculation in the data processing.

### CITATION LIST

### Patent Literature

Patent Literature 1: Korean Registered Patent No. 10-1807658 (Public Date: Dec. 11, 2017)

### SUMMARY OF THE INVENTION

In some embodiments of the present invention, the internal data of a private blockchain system is classified and loaded in a graph database, and graph data (data generated through the classifying process of the internal data) loaded in the graph database is analyzed. It has various advantages as stated below.
The graph database which can best represent and perfectly transplant the internal data of the private blockchain system is employed, and has a clear difference from the existing relational database.
The internal data of the private blockchain system can be stored in the graph database without the normalization or migration.
The internal data of the private blockchain system can be visualized to an intuitively understandable graph, and it is possible to conveniently utilize the database in the blockchain system like a general database by using the graph database.
It is possible to maximize data processing efficiency and to drastically reduce analysis time, and it is possible to query and track the analysis result, such as a state or transaction flow of the system in real time.
The ledger raw data of the private blockchain system is accumulated and loaded in the graph database whenever agreement is made, thereby updating and maintaining the graph data to the latest status.

Some embodiments of the present invention are to provide a system and a method for visualizing the internal data of a private blockchain system to a graph, by using a graph database constructed on the basis of a directional graph theory.

In addition, some embodiments of the invention are to provide a system and a method for making an analysis result for the internal data of a private blockchain system to be checked and visualized in real time, while not giving additional burden to the private blockchain system operated internally with as many loads as possible, thereby helping make business decision.

In addition, some embodiments of the invention are to provide a system and a method for verifying whether data as an analysis target is the same as internal data of a private blockchain system.

However, technical objects to be achieved according to the embodiments of the present invention are not limited to the technical objects described above, and there may be other technical objects.

As a technical means for achieving the technical objects described above, a method for controlling a private blockchain system by a control system according to some embodiments of the present invention may include: a process of acquiring input data of the private blockchain system based on a permissioned distributive ledger technology; a process of classifying the input data into a plurality of nodes, edges among the nodes, and property information dependently added to each of individual nodes and individual edges, and loading them in a graph database generated on a basis of a directional graph theory; a process of analyzing graph data loaded in the graph database; and a process of visualizing the graph data to a graph and displaying the graph on a screen.

Herein, the graph data is a data model represented by points denoting the nodes having the property information, and lines denoting the edges having the property information and connecting the points to each other.

According to an embodiment, the input data may include log data of the private blockchain system.

In this case, the method may further include a process of acquiring the log data from at least one of a plurality of verification peers which constitute the private blockchain system, verify each transaction made in the private blockchain system, bundle a transaction under predetermined conditions agreed to be verified mutually into one block, and distribute and store the block.

In addition, the log data may include CPU usage of the verification peer, memory usage of the verification peer, and network load of the private blockchain system.

According to another embodiment, the input data may include ledger raw data of the private blockchain system.

In this case, the method may further include: a process of selecting one verification peer of a plurality of verification peers which constitute the private blockchain system, verify each transaction made in the private blockchain system, bundle a transaction under predetermined conditions agreed to be verified mutually into one block, and distribute and store the block, on the basis of the graph data; and a process of acquiring the ledger raw data from the selected verification peer.

In addition, the ledger raw data may include information about each transaction made between at least two of a plurality of general peers constituting the private blockchain system and only participating in transactions and the plurality of verification peers.

In addition, in the process of acquiring of the ledger raw data, the ledger raw data may be acquired whenever it is agreed that a certain transaction is verified among the plurality of verification peers.

In addition, the method may further include: a process of acquiring a first hash value for the ledger raw data from the private blockchain system; and a process of verifying the graph data, by comparing the first hash value and a second hash value of the graph data with each other.

According to still another embodiment, the graph data may include first graph data corresponding to the log data of the private blockchain system, second graph data corresponding to the ledger raw data of the private blockchain system, and third graph data corresponding to the processed ledger data generated by processing the ledger raw data.

In this case, in the loading process, the first graph data, the second graph data, and the third graph data may be loaded in individual layers, respectively.

As a technical means for resolving the technical objects described above, a computer-readable recording medium according to some embodiments of the present invention may record a program for executing any one of the methods described above by the control system.

As a technical means for resolving the technical objects described above, a control system for controlling a private blockchain system according to some embodiments of the present invention include: a processor which analyzes graph data loaded in a graph database generated on a basis of a directional graph theory; and a display device which visualizes the graph data to a graph on the basis of the analysis result of the processor and displays the graph on the screen.

Herein, in the graph database, input data of the private blockchain system based on a permissioned distributive ledger technology is classified into a plurality of nodes, edges among the nodes, and property information dependently added to individual nodes and individual edges, and loaded, and the graph data is a data model represented by points denoting the nodes having the property information, and lines denoting the edges having the property information and connecting the points to each other.

According to an embodiment, the input data may include log data of the private blockchain system.

In this case, the log data may be acquired from at least one of a plurality of verification peers which constitute the private blockchain system, verify each transaction made in the private blockchain system, bundle a transaction under predetermined conditions agreed to be verified mutually into one block, and distribute and store the block.

According to another embodiment, the input data may include ledger raw data of the private blockchain system.

In this case, the processor may perform a process of selecting one verification peer of a plurality of verification peers which constitute the private blockchain system, verify each transaction made in the private blockchain system, bundle a transaction under predetermined conditions agreed to be verified mutually into one block, and distribute and store the block, on the basis of the graph data, and the ledger raw data may be acquired from the selected verification peer.

In addition, the ledger raw data may be acquired from the selected verification peer whenever it is agreed that a certain transaction is made among the plurality of verification peers.

In addition, the control system may further include a verifier which verifies the graph data, and the verifier may perform a process of acquiring a first hash value for the ledger raw data from the private blockchain system, and a process of comparing the first hash value and a second hash value of the graph data with each other.

### BRIEF DESCRIPTION OF THE DRAWINGS

FIG. 1 is a schematic diagram illustrating a configuration of a control system according to some embodiments of the present invention;

FIG. 2 is an example diagram for explaining blocks of a blockchain referenced in some embodiments of the present invention;

FIG. 3 is an example diagram for explaining graph data referenced in some embodiment of the present invention;

FIG. 4 is a diagram illustrating a hardware configuration of a control system according to some embodiments of the present invention;

FIG. 5 is a flowchart illustrating a control method for controlling a private blockchain system according to some embodiments of the present invention;

FIG. 6 is an overall diagram illustrating signal processing in a control system according to some embodiments of the invention;

FIG. 7 is an example diagram illustrating a dashboard referenced in some embodiments of the present invention; and

FIG. 8 is an example diagram illustrating a business intelligence tool referenced in some embodiments of the present invention.

### DETAILED DESCRIPTION OF THE PREFERRED EMBODIMENTS

Hereinafter, preferred embodiments of the present invention will be described in detail with reference to the accompanying drawings. Advantages, features, and method for achieving them according to the present invention will be clarified referring to embodiments described below in detail with the accompanying drawings. However, the present invention is not limited to the embodiments described below, may be embodied in various forms different from each other, and is merely provided to complete the description of the present invention and to allow persons skilled in the art in the technical field of the invention completely know the scope of the present invention.

In addition, the present invention covers all possible combinations of embodiments described in the present specification. Various embodiments of the present invention are different from each other, but it should be understood that they do not have to be exclusive from each other. For example, a specific shape, structure, and property may be embodied by other embodiments while not deviating from the spirit and scope of the present invention in relation to an embodiment. In addition, it should be understood that position or disposition of each constituent element in each disclosed embodiment may be modified while not deviating from the spirit and scope of the present invention. Accordingly, the detailed description to be described below is not to be taken as a definite meaning, and the scope of the present invention is limited only by Claims together with all the scopes equivalent to what is claimed if the scope of the invention is properly explained. In the drawings, similar reference numerals and signs denote the same or similar functions over many aspects.

When there is no other definition, all terms (including technical and scientific terms) used in the present specification can be used as meanings understood commonly for persons skilled in the art in the technical field of the present invention. In addition, generally used terms defined in dictionaries are not ideally or excessively interpreted, as long as they are being clearly and specifically defined. The terms used in the present specification are to explain embodiments, and do not limit the present invention. In the present specification, the singular form includes the plural form, unless otherwise noted.

“Comprises” and/or “comprising” used in the specification do not exclude mentioned constituent elements, processes, steps, and operation and/or one or more other constituent elements, processes, steps, operations and/or existence or addition of elements.

In the present specification, “private blockchain system” means a concept contrary to a public blockchain, and denotes a system in which only permissioned peers participate in transactions by using blockchain technology, and each transaction can be queried in real time. Peers are classified into a plurality of verification peers participating in transactions, verifying transactions, bundling transactions satisfying predetermined conditions of transactions agreed to be verified mutually into one block, and distributing and storing the block, and general peers only participating in transactions.

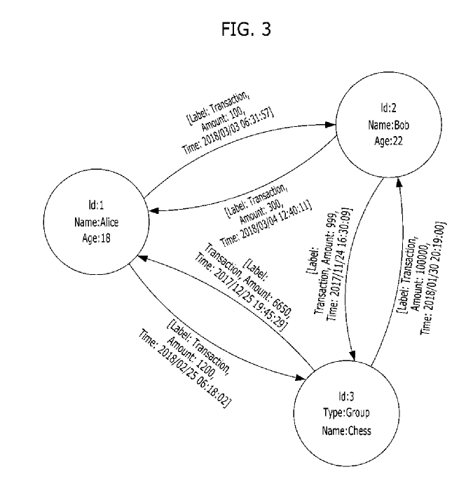

In the present specification, “graph data” denotes a data model represented by points denoting nodes or vertexes having property information about all kinds of data, and lines denoting edges or relationships having property information and connecting the points to each other, and may be exemplarily represented as illustrated in FIG. 3.

In the present specification, “graph database” denotes a database generated on the basis of the directional graph theory, and storing and loading graph data.

Hereinafter, the present invention will be described in more detail with reference to the accompanying drawings.

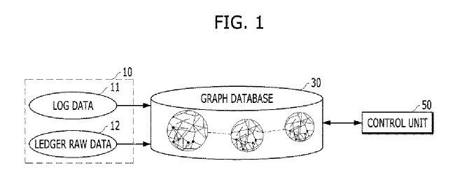

FIG. 1 is a schematic diagram illustrating a configuration of a control system according to some embodiments of the present invention.

A control system for controlling a private blockchain system according to an embodiment of the present invention includes a control unit 50 which performs data processing on a graph database 30, and may further include a separate computing device in addition thereto.

A control system for controlling a private blockchain system according to another embodiment of the present invention includes a graph database 30 and a control unit 50, and may further include a separate computing device in addition thereto.

A control system according to some embodiments of the present invention may further include any one of computing devices such as a smart phone, a laptop computer, a personal digital assistant (PDA), a portable multimedia player (PMP), a navigation device, a slate PC, a tablet PC, a desktop computer, a server, and a web server, etc. The separate computing device described above may display a graphic user interface generated in the control unit 50 to an administrator of the control system and/or a user. In this case, the separate computing device may receive a graphic user interface through the control system 50.

The private blockchain system 10, which is a control target of the control system according to some embodiments of the present invention, may generate log data 11 representing a system state or states of verification peers and/or general peers constituting the system, and ledger raw data 12 including information about transactions between at least two of the plurality of verification peer and the plurality of general peer.

In this case, the private blockchain system 10 may be for transactions between financial institutions and/or public institutions, used car deal, cargo transactions, insurance-related transactions, smart contract-based transactions, decentralized application (Daap)-based transactions, and the like, as well as for well-known cryptocurrency transactions, and has various purposes and uses.

In addition, the private blockchain system 10 is designed to be operated in a completely distributed form in a P2P network type without a central server for control, and performs transactions on the basis of public key cryptography.

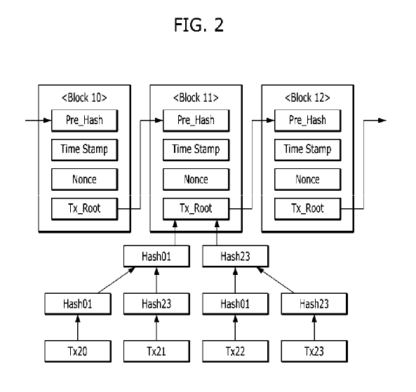

Referring to FIG. 2, the blockchain used in the private blockchain system 10 will be described briefly. FIG. 2 is an example diagram for explaining blocks according to some embodiments of the present invention.

A plurality of transactions on the network gather to form one block, and information about transactions may include additional information in accordance with uses or purposes of the private blockchain system 10, in addition to basic information of ‘who transmitted what and when and to whom.’ Each verification peer performs an operation of proving or verifying each transaction and, specifically, can make the content of the block into hash values by using a nonce value and a SHA256 (secure hash algorithm 256) hash function. In this case, a certain verification peer which found a nonce value making hash values meeting particular conditions generates a block, and can store transaction information (for example, each transaction information within a predetermined time) under predetermined conditions agreed to be proved or verified among verification peers in the generated block. The block generated as described above propagates to each verification peer, is linked in the form of being added to the rear of the previous block, and all the verification peers maintain and manage distributed ledgers having the same transaction information.

The block may include a block header and a block body, and the block header may include, for example, a software/protocol version, a block hash value (Pre_Hash) of the previous block, a root hash value (Tx_Root) positioned in a root of a tree when hash values of each transaction information (Tx 20 to Tx 23) stored in the block body is configured by a Merkle tree, a time (time stamp) when the block is generated, a difficulty adjustment value, and a nonce value.

Specifically, the block hash value is a value calculated by applying the SHA256 function to an input value twice, and is a 32-byte numeric value. The hash function is a function of compressing an input value having an arbitrary length to a data having a fixed length.

A block hash value stored in the twelfth block is a value obtained by hashing a block header of the eleventh block, and a root hash value of the eleventh block is used as an input value when the block hash value stored in the twelfth block is calculated.

If one piece of transaction information is changed, the root hash value is changed. If the root hash value is changed, the block hash value is changed. If the block hash value is changed, the block hash value of the next block is changed. Such chained information change becomes a driving force capable of preventing forgery and manipulation of transaction information, and contributes to the integrity and security of the private blockchain system 10.

In addition, the nonce value may not be used in accordance with an consensus method decided in the private blockchain system 10.

Referring to FIG. 1 again, in some embodiments of the present invention, in the graph database 30, input data of the private blockchain system 10 may be classified into a plurality of nodes, edges among the nodes, and property information dependently added to individual nodes and individual edges, and may be loaded. The input data may include log data 11 of the private blockchain system 10 and ledger raw data 12, may be acquired from the private blockchain system 10 or collected from various collection channels, and may be transmitted to the graph database 30.

FIG. 3 is an example diagram for explaining graph data referenced in some embodiments of the present invention.

The graph data is generated by classification of the input data on a basis of the directional graph theory.

Three nodes are represented by points, and an ID for identifying each node is given thereto. Items such as a name, an age, and a type are property information of each node.

Edges represent inter-relationships of three nodes by lines, and an ID for identifying each edge is given thereto. Items such as a label, a transaction volume, and transaction date and time are property information of each edge.

Each edge has a direction from ‘node A’ to ‘node B’. The direction of each edge is illustrated as an arrow in FIG. 3.

In other words, since the graph data represents all kinds of data in a form similar to the real world, it is suitable for modeling various scenarios.

The graph database 30 in which such graph data is loaded can perfectly transplant each transaction information of the blockchain system, and has a clear difference from the existing relational database. In addition, the graph database 30 can process a complex data set even faster than the existing relational database.

In addition, in the graph database 30, nodes and edges can be represented and stored in a key-value format like the input data of the private blockchain system 10. Accordingly, the graph database 30 can store the input data without extra data processing (for example, normalization, migration, etc.).

The control unit 50 according to some embodiments of the present invention can divisionally manage input data of the private blockchain system 10, can generate graph data from the input data, and can store and load the graph data in the database 30. In addition, the control unit 50 extracts a plurality of nodes and property information of each node from the input data, gives an ID to each of the extracted information, and may set a relationship among the identified nodes. In addition, the control unit 50 can analyze graph data and associative relationship among nodes, visualizes the analysis result, and can provide the visualized analysis result to users.

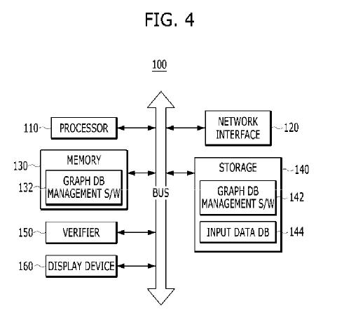

Meanwhile, FIG. 4 is a diagram illustrating a hardware configuration of a control system according to some embodiments of the present invention.

Configurations illustrated in FIG. 4 may be electrically or digitally connected through a bus or may be connected through communication.

A control system 100 which controls a private blockchain system may be a computing device including one or more processors 110, a network interface 120, a memory 130 loading a program executed by the processor 110, a storage 140 storing the program, a verifier 150, and a display device 160.

The processor 110 controls overall operations of the configurations of the control system 100. The processor 110 may be a central processing unit (CPU), a micro-processor unit (MPU), micro controller unit (MCU), or an arbitrary type processor commonly known in the technical field of the present invention.

In addition, the processor 110 can perform an operation or operations for at least one application or program for executing a control method according to some embodiments of the present invention.

In addition, the processor 110 can analyze graph data loaded in a graph database.

Herein, in the graph database, input data of the private blockchain system may be classified into a plurality of nodes, edges among the nodes, and property information dependently added to individual nodes and individual edges, and may be loaded.

According to an embodiment, the input data may include log data of the private blockchain system.

In this case, the log data may be acquired periodically or at all times from at least one of a plurality of verification peers which constitute the private blockchain system, verify each transaction made in the private blockchain system, bundle a transaction under predetermined conditions agreed to be verified mutually into one block, and distribute and store the block.

In addition, the processor 110 may perform a process of detecting at least one problem of the private blockchain system, a process of generating a correction command for instructing to correct operation conditions agreed in advance of the private blockchain system in correspondence with the detection of the problem, and a process of transmitting the generated correction command to each of the plurality of verification peers.

For example, if the overall load of the private blockchain system or the load of the verification peer exceeds a pre-determined value, the problem of the private blockchain system may be detected by the processor 110.

Further, the correction command may be to instruct the maximum number of transactions which can be bundled into one block in the operation conditions agreed in advance to be adjusted. In addition, the correction command may be to instruct a cycle of generating a new block in the operation conditions agreed in advance to be adjusted.

Accordingly, it is possible to reduce the overall load of the private blockchain system or the load of each constituent element (particularly, the verification peer), by adjusting the maximum number of transactions or the cycle of generating the new block in response to the correction command.

In addition, it is possible to improve the detected problem by a customized type.

According to another embodiment, the input data may further include ledger raw data of the private blockchain system in addition to the log data.

In this case, the processor 110 may perform a process of selecting one of a plurality of verification peers which constitute the private blockchain system, verify each transaction made in the private blockchain system, bundle a transaction under predetermined conditions agreed to be verified mutually into one block, and distribute and store the block, on the basis of the graph data. In addition, the ledger raw data may be acquired from the selected verification peer, and may be acquired from the verification peer selected in advance whenever it is agreed that a certain transaction is verified among a plurality of peers.

The verification peer with the minimum load of the plurality of verification peers at a certain time point is selected, and the ledger raw data of the private blockchain system is acquired from the selected verification peer, thereby minimizing burden applied to the private blockchain system itself.

The network interface 120 performs communication with an external device or among internal modules of the control system 100.

The network interface 120 may be embodied by a communication module well known in the technical field of the present invention to support various communication methods. For example, the network interface 120 may be embodied by a wired and wireless communication module, a network card, or an infrared communication module.

In addition, various technologies may be applied to the network interface 120, for example, Wi-Fi, wideband CDMA (WCDMA), high Speed downlink packet access (HSDPA), high speed uplink packet access (HSUPA), high speed packet access (HSPA), world interoperability for microwave access (WiMAX), mobile WiMAX, WiBro, 3rd generation partnership project (3GPP), long term evolution (LTE), long term evolution-advanced (LTE-A), Bluetooth, infrared data association (IrDA), near field communication (NFC), Zigbee, local area network (LAN), wireless local area network (Wireless LAN), wide area network (WAN), and personal area network (PAN).

In addition, in the case of providing a service by connection to the internet, the network interface may conform TCP/IP, which is a standard protocol for information transmission in the internet. In other words, it may mean a worldwide open computer network structure providing hyper text transfer protocol (HTTP), Telnet, file transfer protocol (FTP), domain name system (DNS), simple mail transfer protocol (SMTP), simple network management protocol (SNMP), and network file service (NFS), network information service (NIS).

According to some embodiments, the network interface 120 may be connected to the private blockchain system and/or the graph database through a network, and may be connected to a separate computing device.

The memory 130 stores various kinds of data, commands and/or information. The memory 130 can load one or more programs from the storage 140 to perform the control method according to some embodiments of the present invention.

The memory 130 may be, for example, a RAM, and may be a RAM well known in the technical field of the present invention, such as SRAM, DRAM, PSRAM, SDPARM, and DDR SDRAM.

The memory 130 loads a graph DB management software 142 stored in the storage 140 to be executed by the processor 110, and a graph DB management software 132 may be temporarily stored in the memory 130 in the course of execution. The graph DB management software 132 is executed by the processor 110, thereby executing one or more commands for performing functions and/or operations of the control system 110.

The storage 140 may store the graph DB management software 142 exemplified as a computer program, and may also store the database 144 about input data of the private blockchain system. In addition, the storage 140 may also store the graph database 30 separately illustrated in FIG. 1. In addition, the storage may also store various kinds of information for performing the control method according to some embodiment of the present invention.

Herein, the graph database 30 and the database 144 about input data must be distinguished. The database 144 about input data merely copies and stores or loads input data as it is, but the graph database 30 extracts nodes, relationship, and property information from acquired input data, and stores or loads graph data generated by identifying and analyzing each constituent element. The graph data and the input data (including log data and raw ledger data) are in relationship corresponding to each other, and the graph data of the graph database 30 may be continuously updated. Further, the graph visualized by the graph data and a general graph (bar graph, line graph, 3D graph, chart, diagram, etc.) in mathematics or statistics must be distinguished.

The storage 140 may include: a non-volatile memory such as a read only memory (ROM), an erasable programmable ROM (EPROM), an electrically erasable programmable ROM (EEPROM), and a flash memory, a hard disk, a removable disk, or a computer-readable recording medium in an arbitrary form well known in the technical field of the present invention.

The verifier 150 can verify graph data.

According to another embodiment, input data may include ledger raw data of the private blockchain system.

In this case, the verifier 150 can perform a process of acquiring a first hash value for ledger raw data from the private blockchain system, and a process of comparing the acquired first hash value and a second hash value of graph data with each other. The second hash value may be calculated by analyzing the graph data.

Through the verification process of the verifier 150, it can be confirmed that the ledger raw data and the graph data maintain identity with respect to each other (data integrity), and reliability and accuracy for analysis results (dashboard, business intelligence tool, etc.) based on graph data can be improved.

Although the verifier 150 is illustrated as a separate configuration in FIG. 4, the verifier 150 may be integrated with the processor 110. In this case, the processor 110 may perform the verification process.

The display device 160 can display various graphic user interfaces on the screen.

In addition, the display device 160 can display state information of the private blockchain system on the basis of the analysis result of the process 110, or can visualize graph data to a graph and display the graph in real time.

Log data is acquired periodically or at all times, and ledger raw data is acquired whenever it is agreed that a certain transaction is verified. Accordingly, it is possible to display and track internal data change of the private blockchain system in real time.

Log data also may be acquired at specific times periodically and the acquisition period of the log data may be set or pre-scheduled depending on performance of the control system 100 and network load.

In addition to the configurations illustrated in FIG. 4, the control system 100 may further include various configurations related to some embodiments of the present invention.

For example, the control system 100 may include an input device which generates a signal for querying or tracking graph data and an analysis result in correspondence with input of a user and/or an administrator, and the input device may be configured integrally with the display device 160.

In addition, the control system 100 may further include a graph query processing engine which receives query language of a user, accesses graph data, and performs query and traversal. The graph query engine can perform operations such as creating, querying, correcting, and deleting of at least one of nodes, edges, and property information of graph data while visiting the whole configurations of the graph database.

According to some embodiments of the present invention described so far, it is possible to visualize the internal data of the private blockchain system, and it is possible to maximize data processing efficiency, and it is possible to analyze the private blockchain system in real time.

Hereinafter, the operation of the control system 100 for controlling the private blockchain system will be described in more detail. It is assumed that the following processes or steps are performed by the control system 100.

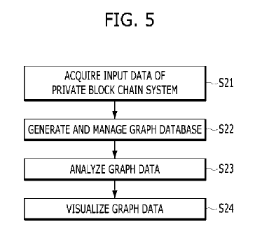

FIG. 5 is a flowchart of the private blockchain system according to some embodiments of the present invention.

A control system 100 acquires input data including load data of a private blockchain system (S21).

Then, the control system 100 generates and manages a graph database on the basis of the acquired input data (S22). Specifically, the control system 100 classifies the input data (log data) into a plurality of nodes, edges among the nodes, and property information dependently added to each of individual nodes and individual edges, and loads in the graph database.

Then, the control system 100 analyzes the graph data loaded in the graph database (S23).

Then, the control system 100 displays state information of the private blockchain system on the screen, or visualizes the graph data to a graph and displays the graph (S24). The state information and/or the graph are provided to a user.

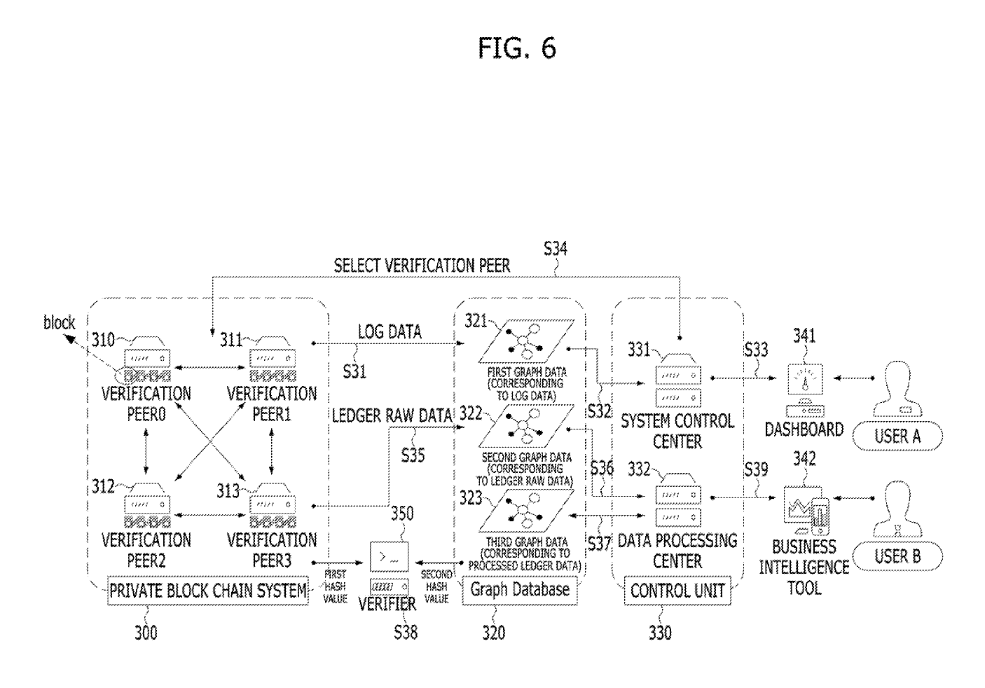

Meanwhile, FIG. 6 is a diagram illustrating overall signal processing in the control system according some embodiments of the present invention.

A private blockchain system 300 may include a plurality of verification peers 310, 311, 312, and 313 and general peers (not illustrated). The verification peers 310, 311, 312, and 313 verify transactions made in the private blockchain system 300, bundle transactions under predetermined conditions agreed to be verified mutually into one block, and distribute and store the block.

According to an embodiment, the control system for controlling the private blockchain system 300 includes a control unit 330 performing network communication with a graph database 320. According to another embodiment, the control system includes a graph database 320 and a control unit 330.

Log data of the private blockchain system 300 is transmitted at ordinary times from at least one of a plurality of verification peers constituting the private blockchain system 300 to the control system (S31).

In this case, the log data may include CPU usage of each verification peer, memory usage of each verification peer, and network load of the private blockchain system 300.

The log data is classified into nodes, edges, and property information and loaded in the graph database 320, and first graph data corresponding to the log data is loaded in a first layer 321 of the graph database 320.

A system control center 331 of the control unit 330 analyzes and processes the first graph data (S32) and outputs an analysis result or a data processing result (S33), and the analysis result or the data processing result is displayed on the screen in the form of a dashboard 341.

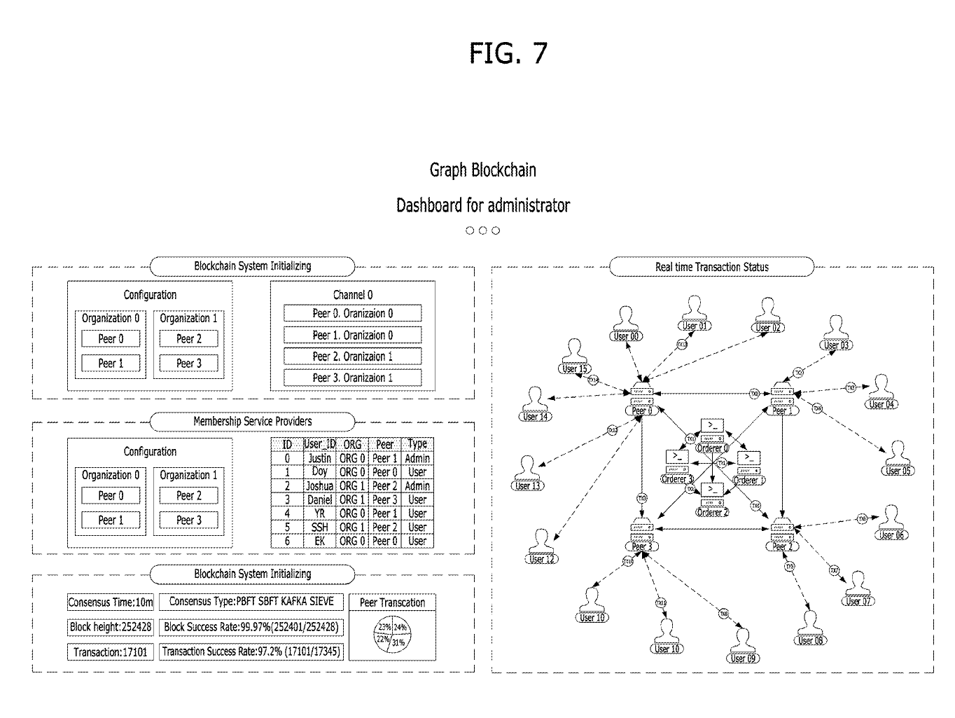

FIG. 7 is an example diagram illustrating a dashboard referenced in some embodiments of the present invention.

As illustrated in FIG. 7, from the dashboard, it is possible to confirm an initial state, member information, overall state information, real-time transaction status information, and the like of the private blockchain system 300.

For example, the graph visualized by the graph data, consensus time, the number of block height, the number of transaction, a consensus type, a block success rate, a transaction rate, and verification peer information (id, User id, peer number, type, organization, channel, etc.) are displayed in the form of the dashboard on the screen.

Accordingly, a User A can confirm a state of the private blockchain system 300 or states of verification peers and/or general peers constituting the system 300.

The system control center 331 detects at least one problem (abnormal state) of the private blockchain system on the basis of the analysis result or the data processing result.

The system control center 331 generates a correction command for instructing to correct operation conditions agreed in advance of the private blockchain system in correspondence with the detection of the problem, and transmits the generated correction command to each of the plurality of verification peers.

The problem-related operation of the system control center 331 may be performed automatically or by receiving input of the User A, and the private blockchain system 300 can correct the problem due to the problem-related operation.

In addition, the system control center 331 selects one verification peer of the plurality of verification peers on the basis of the graph data (particularly, the first graph data) (S34).

Since the private blockchain system 300 is under significant load on its own, the system control center 331 selects a verification peer with a minimum load degree comprehensively considering CPU usage of each verification peer, memory usage of each verification peer, and network load.

For example, if the third verification peer 313 is a verification peer with the minimum load at a certain time point, ledger raw data of the private blockchain system 300 is transmitted from the third verification peer 313 to the control system (S35). The verification peer with the minimum load may be varied in accordance with the time point when the system control center 331 performs the course of selecting the verification peer.

In addition, the ledger raw data may be transmitted to the control system whenever it is agreed that a certain transaction is verified among a plurality of verification peers.

In this case, the ledger raw data may include information about each transaction made between at least two of the plurality of general peers constituting the private blockchain system 300 and only participating in transactions and the plurality of verification peers.

The ledger raw data is classified into nodes, edges, and property information and loaded in the graph database 320, and the second graph data corresponding to the ledger raw data is loaded in the second layer 322 of the graph database 320.

The data processing center 332 of the control unit 330 analyzes the second graph data, and generates ledger data processed through data processing (S36).

The processed ledger data is classified into nodes, edges, and property information and loaded in the graph database 320, and the third graph data corresponding to the processed ledger data is loaded in the third layer 323 of the graph database 320 (S37).

In other words, the graph data includes first graph data corresponding to the log data of the private blockchain system 300, second graph data corresponding to the ledger raw data of the private blockchain system 300, and third graph data corresponding to the processed ledger data, and the graph database 320 loads the first graph data, the second graph data, and the third graph data in individual layers, respectively.

A verifier 350 acquires a first hash value for the ledger raw data from the private blockchain system 300, and compares the first hash value and a second hash value of the graph data with each other, thereby verifying the graph data (S38).

The graph data loaded in the graph database is verified through comparison of hash values, thereby improving reliability and accuracy for the analysis result.

The data processing center 332 outputs the analysis result or the data processing result (S39), and the analysis result or the data processing result is displayed in the form of a business intelligence tool 342 on the screen.

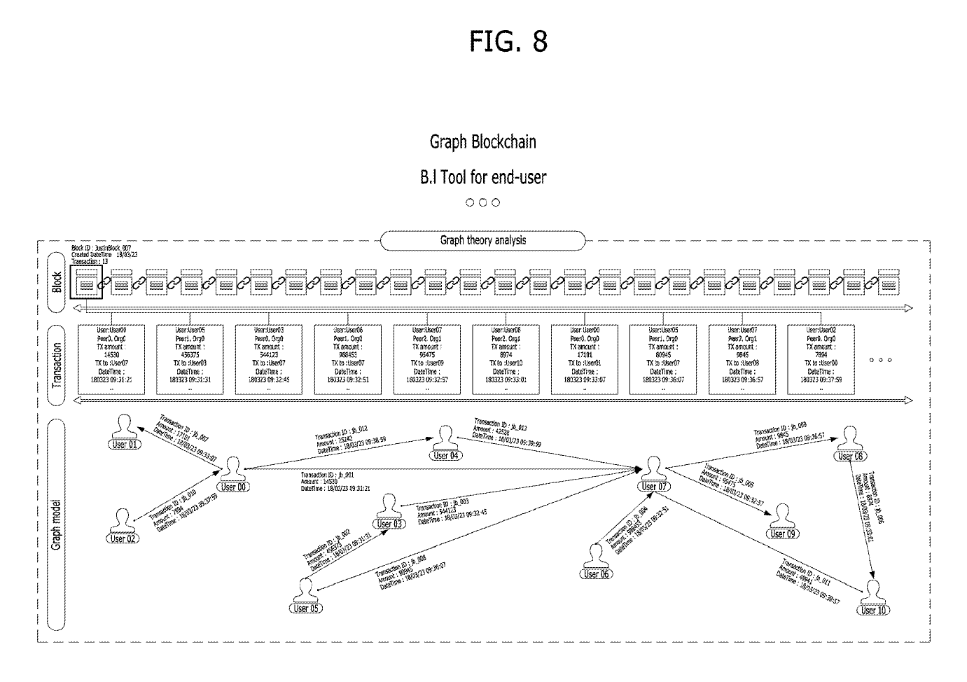

FIG. 8 is an example diagram illustrating a business intelligence tool referenced in some embodiments of the present invention.

As illustrated in FIG. 8, in the business intelligence tool, it is possible to query and track information about each transaction history recorded in a certain block of the private blockchain system 300, and it is possible to visually confirm associative relationships among nodes making a transaction.

For example, the graph visualized by the graph data, and each transaction information (User, peer number, TX amount, TX to, time, etc.) in the certain block selected by a User B are displayed in the form of the business intelligence tool on the screen.

Accordingly, a User B can confirm and track flow of transactions made in the private blockchain system 300, and can utilize the analysis result or the data processing result from various perspectives on business.

For example, it is assumed that the private blockchain system 300 is a system for a used car deal and in a transaction No. 256 ‘[2018/03/03 06:31:57] a Seller A received 100 dollars from a Buyer B and sold a truck X in Seoul by a direct contract method’ was made. A plurality of verification peers 310, 311, 312, and 313 verify the transaction No. 256, respectively, and agree that the transaction is valid. Information about the transaction No. 256 is bundled and stored in a newly generated block together with information about other used car deals meeting particular conditions, and the block is additionally linked to the blockchain of each verification peer. The control system acquires log data and ledger raw data directly and indirectly related to the transaction No. 256, generates graph data corresponding to each of the data, and loads and manages the graph data in the graph database 320. The graph data of the graph database 320 is processed by the control unit 330. The User A can confirm the analysis result or the data processing result of the first graph data 321 through the dashboard 341, and the User B can confirm the analysis results or the data processing results of the second graph data 322 and the third graph data 323 through the business intelligence tool 342. Particularly, the User B can query and track the transaction No. 256 and other transactions associated therewith in accordance with his or her purpose and use anytime.

Meanwhile, some embodiments of the present invention may be embodied in the form of a computer-readable recording medium in which a program for executing computer-executable commands executable or a program for executing at least one method of the control methods of the control system described above is recorded. The computer-readable recording medium may be an arbitrary available medium which can be accessed by a computer, and includes all volatile and non-volatile mediums and removable and non-removable mediums. In addition, the computer-readable recording medium may include a computer storage medium. The computer storage medium includes all volatile, non-volatile, removable, and non-removable mediums embodied by arbitrary methods or technology for storing information such as computer-readable commands, a data structure, a program module, or other data.

The method and system according to the present invention have been described with reference to specific embodiments, but some or all of the constituent elements or operations may be embodied by using a computer system having universal hardware architecture.

The above description of the present invention is for illustration purposes only, and it should be understood that persons skilled in the art in the technical field of the present invention can easily modify the embodiments to other specific forms without changing the technical spirit or essential features of the present invention. Therefore, it should be understood that the embodiments described above are exemplary in all aspects, and is not definitive. For example, each constituent element described as a single type may be embodied as distributed. Similarly, constituent elements described as distributed may be embodied in the combined type.

The scope of the present invention is represented by Claims to be described below rather than the detailed description, and it should be interpreted that all modifications and modified forms derived from the meaning and scope of Claims and equivalent concept thereof are included in the scope of the present invention.

What is claimed is:

1. A method for controlling a private blockchain system by a control system comprising:
a process of acquiring input data of the private blockchain system based on a permissioned distributive ledger technology;
a process of classifying the input data into a plurality of nodes, edges among the nodes, and property information dependently added to each of individual nodes and individual edges, and loading them in a graph database generated on a basis of a directional graph theory;
a process of analyzing graph data loaded in the graph database; and
a process of visualizing the graph data to a graph and displaying the graph on a screen,
wherein the graph data is a data model represented by points denoting the nodes having the property information, and lines denoting the edges having the property information and connecting the points to each other.

2. The method according to claim 1, wherein the input data includes log data of the private blockchain system, and
wherein the method further comprises a process of acquiring the log data from at least one of a plurality of verification peers which constitute the private blockchain system, verify each transaction made in the private blockchain system, bundle a transaction under predetermined conditions agreed to be verified mutually into one block, and distribute and store the block.

3. The method according to claim 2, wherein the log data includes CPU usage of the verification peer, memory usage of the verification peer, and network load of the private blockchain system.

4. The method according to claim 1, wherein the input data includes ledger raw data of the private blockchain system, and
wherein the method further comprises:
a process of selecting one verification peer of a plurality of verification peers which constitute the private blockchain system, verify each transaction made in the private blockchain system, bundle a transaction under predetermined conditions agreed to be verified mutually into one block, and distribute and store the block, on the basis of the graph data; and
a process of acquiring the ledger raw data from the selected verification peer.

5. The method according to claim 4, wherein the ledger raw data includes information about each transaction made between at least two of a plurality of general peers constituting the private blockchain system and only participating in transactions and the plurality of verification peers.

6. The method according to claim 4, wherein in the process of acquiring of the ledger raw data, the ledger raw data is acquired whenever it is agreed that a certain transaction is verified among the plurality of verification peers.

7. The method according to claim 1, wherein the graph data includes first graph data corresponding to the log data of the private blockchain system, second graph data corresponding to the ledger raw data of the private blockchain system, and third graph data corresponding to the processed ledger data generated by processing the ledger raw data, and
wherein in the loading process, the first graph data, the second graph data, and the third graph data are loaded in individual layers, respectively.

8. The method according to claim 1, wherein the input data include ledger raw data of the private blockchain system, and
wherein the method further comprises:
a process of acquiring a first hash value for the ledger raw data from the private blockchain system; and
a process of verifying the graph data, by comparing the first hash value and a second hash value of the graph data.

9. A computer-readable recording medium which records a program for executing the method according to claim 1.

10. A control system for controlling a private blockchain system comprising:
a processor which analyzes graph data loaded in a graph database generated on a basis of a directional graph theory; and
a display device which visualizes the graph data to a graph on the basis of the analysis result of the processor and displays the graph on the screen,
wherein in the graph database, input data of the private blockchain system based on a permissioned distributive ledger technology is classified into a plurality of nodes, edges among the nodes, and property information dependently added to individual nodes and individual edges, and loaded, and
wherein the graph data is a data model represented by points denoting the nodes having the property information, and lines denoting the edges having the property information and connecting the points to each other.

11. The control system according to claim 10, wherein the input data includes log data of the private blockchain system, and
wherein the log data is acquired from at least one of a plurality of verification peers which constitute the private blockchain system, verify each transaction made in the private blockchain system, bundle a transaction under predetermined conditions agreed to be verified mutually into one block, and distribute and store the block.

12. The control system according to claim 10, wherein the processor performs a process of selecting one of a plurality of verification peers which constitute the private blockchain system, verify each transaction made in the private blockchain system, bundle a transaction under predetermined conditions agreed to be verified mutually into one block, and distribute and store the block, on the basis of the graph data,
wherein the input data includes ledger raw data of the private blockchain system, and
wherein the ledger raw data is acquired from the selected verification peer.

13. The control system according to claim 12, wherein the ledger raw data is acquired from the selected verification peer whenever it is agreed that a certain transaction is verified among the plurality of verification peers.

14. The control system according to claim 10, wherein the input data include ledger raw data of the private blockchain system,
wherein the control system further comprises a verifier which verifies the graph data,
wherein the verifier performs a process of acquiring a first hash value for the ledger raw data from the private blockchain system, and a process of comparing the first hash value and a second hash value of the graph data with each other.
